(19) United States
(12) Patent Application Publication
(10) Pub. No.: US 2004/0014358 A1
(43) Pub. Date: Jan. 22, 2004

(54) Angled coaxial plug connector

(75) Inventor: Ludger Leve, Rahden (DE)

Correspondence Address: Norman P. Soloway, HAYES SOLOWAY P.C., 130 W. Cushing Street, Tucson, AZ, 85701, US

(73) Assignee: HARTING Automotive GmbH & Co. KG

(21) Appl. No.: 10/620,264

(22) Filed: Jul. 15, 2003

(30) Foreign Application Priority Data
Jul. 18, 2002 (DE) 102 32 662.2

(51) Int. Cl. H01R 9/05

(52) U.S. Cl. 439/581

(57) ABSTRACT

A coaxial plug connector comprises fist and second receiving chambers which are surrounded by first and second metal sleeves, respectively. The first metal sleeve is made up of first and second half shells which are placed one on top of the other. The second metal sleeve is inserted in the first half shell.

### TECHNICAL FIELD

The invention relates to a coaxial plug connector comprising first and second receiving chambers which are surrounded by first and second a metal sleeves, respectively.

### BACKGROUND OF THE INVENTION

Arranged in the interior of the coaxial plug connector is usually an inner conductor which extends from the one to the other receiving chamber. A cable can for instance be connected to one end of the inner conductor, and a further coaxial plug connector can be plugged into the other end. The two metal sleeves provide here for a continuous shielding between the two receiving chambers.

With all known constructions of such coaxial plug connectors there is the problem of how the inner conductor can be arranged in the interior of the coaxial plug connector and anchored there with an as low an expenditure as possible.

It is the object of the invention to further develop a coaxial plug connector of the type initially mentioned to the effect that particularly low manufacturing expenses are achieved.

### BRIEF SUMMARY OF THE INVENTION

According to the invention, a coaxial plug connector comprising first and second receiving chambers which are surrounded by first and second metal sleeves, respectively. The first metal sleeve is made up of first and second half shells which are placed one on top of the other. The second metal sleeve is inserted in the first half shell. The invention is based on the basic idea to divide the coaxial plug connector into two subunits which be manufactured separately from each other. It is during assembly that the inner conductor can then be inserted in one of the subunits; the inner conductor will then automatically be fixed with the attaching of the second subunit.

According to the preferred embodiment of the invention it is provided for that the first and second half shells are latched with each other. In this way the two half shells are secured to each other already during their assembly, so that a high positional accuracy is produced.

In particular, provision can be made in that one of the first and second half shells has a cut-out and the other half shell has a retaining lug engaging into the cut-out. This allows a particularly simple and attractively-priced securing.

According to the preferred embodiment of the invention provision is made that a crimping sleeve is attached to the first metal sleeve so as to be arranged at a distance from the latching point of the two half shells, the crimping sleeve securing the two half shells to each other. In this way the two half shells can be secured to each other in a particularly easy manner by means of simple method steps which are easily to automate: There is only the need of hanging the one half shell with its retaining lug into the other half shell, slipping the crimping sleeve over the two half shells and crimping it.

According to the preferred embodiment of the invention provision is made that the second metal sleeve is flanged in the interior of the first half shell. In this way the second metal sleeve can be attached in the first half shell in a particularly simple manner.

According to the preferred embodiment of the invention provision is made that arranged in the interior of the second metal sleeve is a first dielectric plastic body having a mount in which an inner conductor is arranged. The first plastic body can be injected into the second metal sleeve and anchored there in an easy manner. In particular, provision is made here that the second metal sleeve is provided with a plurality of small passage openings through which the fast plastic body extends as far as to the outer side of the second metal sleeve.

According to the preferred embodiment of the invention a second dielectric plastic body is provided so as to be arranged in the second half shell. Together with the first plastic body extending preferably as far as into the first half shell, the second plastic body can fill up the receiving chamber in the first metal sleeve in a suitable manner and, for example, form therein a strain relief for a cable which can be fixed in the inner conductor by crimping.

It is preferably provided for that the first and second plastic bodies are latched with each other. Provision can be made, in particular, that one of the plastic bodies has a protrusion which engages into a recess in the other plastic body. In this way the plastic bodies secured to each other, so that a higher stability of the first metal sleeve is produced.

According to the preferred embodiment of the invention provision is made that the second plastic body rests at the inner conductor such that the latter is firmly held in its mount. This makes it possible to arrest the inner conductor in the first plastic body without further measures solely by placing the second half shell onto the first one, pressing against the inner conductor by means of the second plastic body arranged in it.

The first and second half shells preferably overlap each other along their longitudinal edges at least in part, and the second metal sleeve overlaps the first half shell. This ensures a particularly good HF shielding, because the two) metal sleeves are completely closed in circumferential direction with no gap existing between them.

According to the preferred embodiment of the invention provision can be made that the first and second metal sleeves are arranged at right angles to each other, i.e. a right-angled coaxial plug connector being formed.

### BRIEF DESCRIPTION OF THE DRAWINGS

FIG. 1 shows a coaxial plug connector in a perspective view;

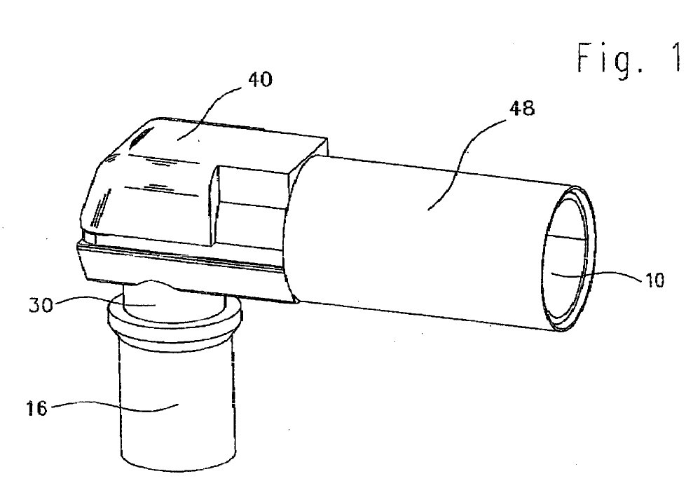

FIG. 2 shows in an exploded view the components of the coaxial plug connector of FIG. 1;

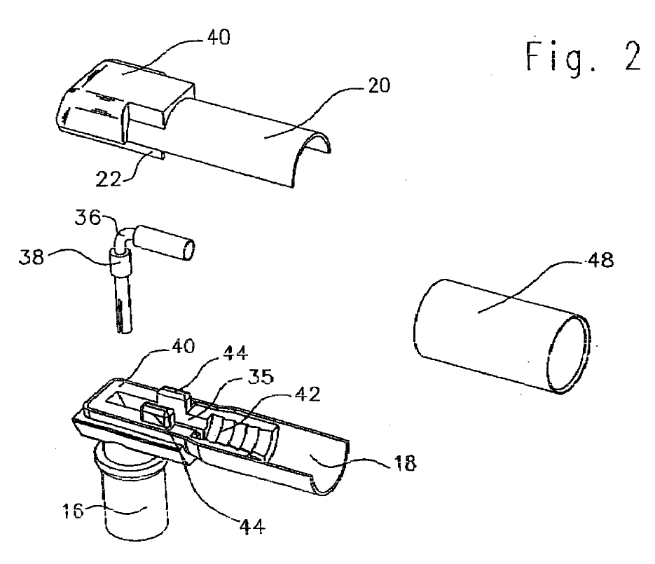

FIG. 3 shows in a perspective view the first metal sleeve, the second metal sleeve and the crimping sleeve of the coaxial plug connector of FIG. 1; and

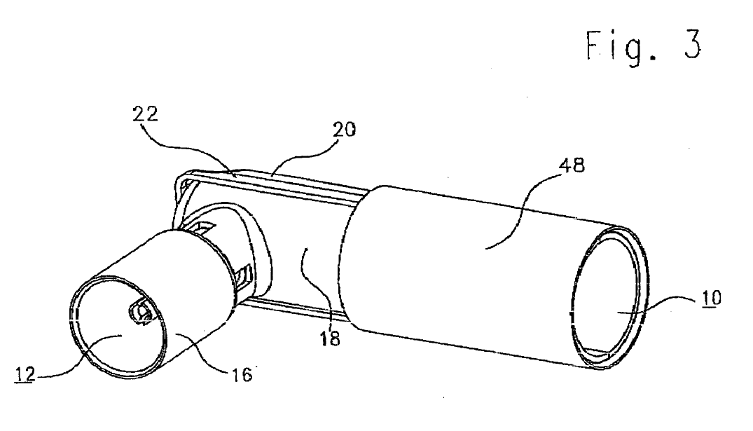

FIG. 4 shows the coaxial plug connector of FIG. 1 in a sectional view.

### DETAILED DESCRIPTION OF THE PREFERRED EMBODIMENT

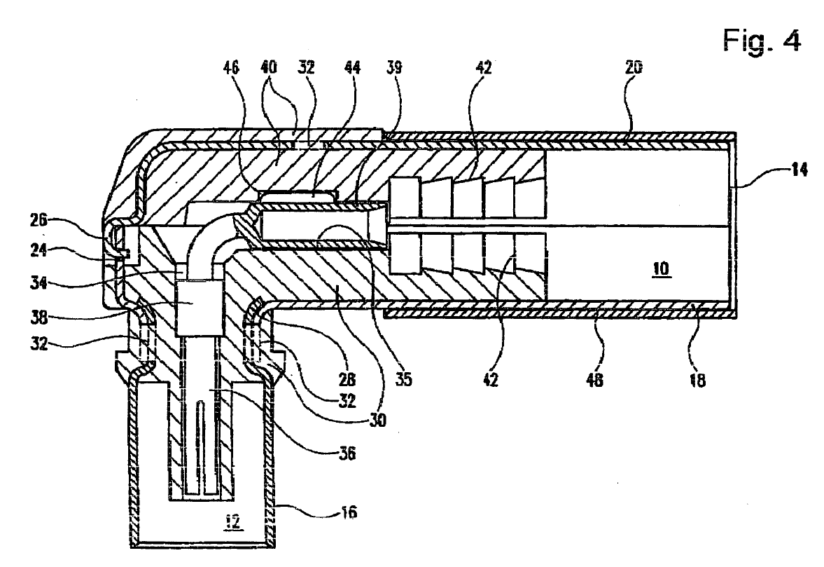

FIG. 4 shows a right-angled coaxial plug connector which has a first receiving chamber 10 and a second receiving chamber 12. These arm surrounded by a fist metal sleeve 14 and a second metal sleeve 16, respectively.

The first metal sleeve 14 is constituted by a first half shell 18 and a second half shell 20. The left-hand half of the first half shell 18, regard the Figures, is realized so as to have a slightly smaller width, whilst the second half shell 20 is formed continuously with the same width, namely the width of the right-hand half of the first half shell 18. The second half shell 20 has its left-hand half provided with two skirts 22 which overlap the area with reduced width of the first half shell 18. In the right-hand half regarding the Figures, the first and second half shells 18, 20 rest against each other in butt contact, so that the cylindrical receiving chamber is formed.

The left end of the first half shell 18, regarding the Figures, is provided with a cutout 24 which is engaged by a retaining lug 26 on the second half sell 20. The cut-out 24 together with the retaining lug 26 forms a hinge between the two half shells.

Inserted in the first half shell 18 is the second metal sleeve 16, to be precise on its underside facing away from the second half shell 20. For being fixed in the first half shell 18 the second metal sleeve 16 is provided with a flanged edge 28.

Arranged in the interior of the second metal sleeve 16 and the first half shell 18 is a first plastic body 30 made of a dielectric material. The plastic body 30 is injected in the second metal sleeve 16 and the first half shell, which both are provided with small passage openings 32 through which the first plastic body 30 extends as far as to the outer side of the second metal sleeve 16 and of the first half shell 18, too. Formed in the first plastic body 30 is a mount 34 which is made in the nature of a stepped bore and has a receiving nut 35 in the area of the half shell 18. A metallic inner conductor 36 with a 90° bend can be inserted in the mount 34 and has an arresting collar 38. The end of the inner conductor pointing downward with respect to the Figures is configured as a plug-in portion, and the end pointing to the right as a crimping portion 39,

A second plastic body 40, which likewise is made of a dielectric material, is injected into the second half shell 20. The second plastic body likewise extends through small passage openings in the second half shell 20 as far as to the outer side thereof. Further, there are provided grooves for a strain relief.

The first plastic body 30 and the second plastic body 40 are each provided with several grooves 42 which put together form a strain relief for a cable. Furthermore, the first plastic body 30 is provided with two protrusions which engage into complementary recesses 46 in the second plastic body 40.

Finally, there is provided a crimping sleeve 48 which is slipped on the right-hand half of the first half shell 18 and of the second half shell 20 and can be crimped there.

Producing the coaxial plug connector described is performed in the following way: First the two half shells 18, 20 are stamped and deep-drawn. Subsequently the second metal sleeve 16 is inserted in the first half shell 18 and is flanged there. Then the first plastic body 30 is injected into the second metal sleeve 16 and the first half shell 18, and the second plastic body 40 is injected into the second half shell 20.

Afterwards a cable can be inserted in the crimping portion 39 of the inner conductor 36 and fixed there by crimping. The inner conductor 36 thus prepared is then inserted in this condition into the mount 34 in the first plastic body 30 in such a manner that its arresting collar 38 rests at to step of the stepped bore of the mount 34 and the crimping portion lies in the receiving groove 35. The second half shell 20 is then placed on the fist half shell is, by hanging the retaining lug 26 of the second half shell 20 into the cut-out 24 of the first half shell 18. To this end the second half shell 20 is placed on the fist half shell 18 from above in oblique direction. After having hung in, the second half shell 20 can be tipped down onto the first half shell 18, the skirts 22 overlapping the left-hand half of the first half shell 18 and the recesses 46 of the second plastic body 40 reaching over the protrusions 44 of the first plastic body 30. In this way the second half shell 20 is locked to the fist half shell 18 in longitudinal and transverse directions. In this arrangement, the second plastic body rests on the crimping portion 39 of the inner conductor 36, so that the latter is firmly arrested in the mount 34 and the receiving groove 35. At the same time the grooves 42 of the plastic bodies engage on the cable, provided in the crimping portion 39, and retain it, so hat a strain relief is formed.

Subsequently, the crimping sleeve 48 is slipped on the right-hand half of the fist half shell 18 and of the second half shell 20 and is crimped there. The crimping sleeve 48 ensures that the second half shell 20, in the area of its right-hand half, can not be lifted off from the first half shell 18; in thc area of the left-hand half the hinge, formed by the retaining lug 26 and the cut-out 24, ensures that the two half shells are firmly connected with each other. Further, the crimping portion make available both the strain relief through the dielectric plastic body and a reliable shielding transfer of a shielding braid of the cable to the metal sleeve 14.

The coaxial plug connector formed in this way shows a particularly good RF shielding. The second metal sleeve 16 is closed all round, so that a complete shielding is guaranteed here. The small passage openings 32 do not have a detrimental effect on the RF shielding, because their diameter is smaller than the wavelength of the RF radiation. A perfect RF shielding is also achieved in the area of the first and second half shells 18, 20. In the left-hand half of the two half shells, regarding the Figures, the half shells overlap each other due to the skirt 22. In the area of the right-hand half, the crimping sleeve 48 closed all round ensures the good shielding effect. In spite of the good RF shielding the coaxial plug connector can be produced and assembled in a particularly easy manner, as there are only required few assembling stops which can easily be automated.

1. A coaxial plug connector comprising first and second receiving chambers which are surrounded by first, and second metal sleeves, respectively, said first metal sleeve being made up of first and second half shells which are placed one on top of the other, and said second metal sleeve being inserted in said first half shell.

2. The coaxial plug connector according to claim 1, wherein said first and second half shells are latched with each other.

3. The coaxial plug connector according to claim 1, wherein one of said first ad second half shells has a cut-out and the other of said half shells has a retaining lug engaging into said cut-out.

4. The coaxial plug connector according to claim 2, wherein a crimping sleeve is attached to said first metal sleeve so as to be arranged at a distance from a latching point of said two half shells, said crimping sleeve securing said two half shells to each other.

5. The coaxial plug connector according to claim 1, wherein said second metal sleeve is flanged in an interior of said first half shell.

6. The coaxial plug connector according to claim 1, wherein arranged in an interior of said second metal sleeve is a first dielectric plastic body having a mount in which an inner conductor is arranged.

7. The coaxial plug connector affording to claim 6, wherein said second metal sleeve is provided with a plurality of small passage openings through which said first plastic body extends as far as to an outer side of said second metal sleeve.

8. The coaxial plug connector according to claim 6, wherein said first plastic body extends as far as into said first half shell.

9. The coaxial plug connector according to claim 6, wherein a second dielectric plastic body is provided so as to be arranged in said second half shell.

10. The coaxial plug connector according to claim 9, wherein said second half shell is provided with a plurality of small passage openings through which said second plastic body extends as far as to an outer side of said second half shell.

11. The coaxial plug connector according to claim 9, wherein said first and second plastic bodies ale latched with each other.

12. The coaxial plug connector according to claim 11, wherein one of said plastic bodies has a protrusion which engages into a recess in the other one of sad plastic bodies.

13. The coaxial plug connector according to claim 9, wherein said second plastic body rests at said inner conductor such that it is firmly held in said mount.

14. The coaxial plug connector according to claim 9, wherein said first and second plastic bodies are provided with ribs which form a strain relief for a cable that can be crimped so as to be fixed in a crimping portion of said inner conductor.

15. The coaxial plug connector according to claim 1, wherein said first and second half shells have longitudinal edges along which they overlap at least in part and wherein said second metal sleeve overlaps said first half shell.

16. The coaxial plug connector according to claim 1, wherein said first and second metal sleeves are arranged at right angles to each other.
